(19) United States
(12) Patent Application Publication
(10) Pub. No.: US 2019/0289825 A1
(43) Pub. Date: Sep. 26, 2019

(54) Slidable Leash

(71) Applicant: Jonathan Blubaugh, Waynesboro, PA (US)

(72) Inventor: Jonathan Blubaugh, Waynesboro, PA (US)

(21) Appl. No.: 16/361,894

(22) Filed: Mar. 22, 2019

Related U.S. Application Data
(60) Provisional application No. 62/646,713, filed on Mar. 22, 2018.

(51) Int. Cl. A01K 27/00; A01K 15/02

(52) U.S. Cl. CPC A01K 27/005; A01K 27/003; A01K 27/008; A01K 15/025

(57) ABSTRACT

A quick leash system includes a flexible elongated member having a proximal end and a distal end, a handle portion disposed at the proximal end of said flexible elongated member, and a stopper attached to the flexible elongated member at a position at or near the distal end of said flexible elongated member, wherein the handle portion and the flexible elongated member are configured to move unabated through the pass-through engagement until the stopper prevents the distal end of the flexible elongated member from passing through the pass-through engagement.

### CROSS-REFERENCE TO RELATED APPLICATION

The present patent application claims the benefit of the filing date of U.S. Provisional Patent Application No. 62/646,713 filed on Mar. 22, 2018, the disclosure of which is incorporated by reference as if fully stated herein.

### BACKGROUND

### Field of the Disclosure

The present disclosure relates to a “slidable leash” herein.

### Description of Related Art

Leashes and leads are used to walk or lead animals. For instance, leashes may be used to walk or lead animals such as dogs, cats, horses, goats, pigs, lambs, exotic animals, humans, and/or the like.

Existing examples of leashes include a length of rope or cord having a handle at one end and a clip at the other end. The clip is configured to clip onto the collar of the animal that is to be walked or led. An example of a known clip includes a bolt snap having a spring-loaded catch designed to be articulated by a user's thumb or hand.

In some examples, a recognized problem with leashes having clips is that engaging or removing such a leash requires a user to graph or manipulate the collar near the animal's throat. Many times, this can cause discomfort for an animal as a clip is engaged or disengaged. In some examples, this also can result in increased probability that an unfriendly animal may bite the user during engagement or removal of the leash. Additionally, use of a clip may require additional time to engage or disengage the leash, lengthening the discomfort and/or increased probability of biting.

Further, known examples of clips may be difficult or uncomfortable for a user to manipulate as they are relatively small and require relatively fine movements to operate. This might be especially uncomfortable for users with hand pain, or who are otherwise unable to engage in fine motor movements of hands and/or fingers.

Accordingly, a need exists for an improved mechanism for engaging a leash to an animal to be walked or led. Preferably, this improved mechanism would allow for a leash to be engaged more quickly than by known mechanisms. Additionally, it is preferable if the improved mechanism requires fewer fine motor movements by a user than known mechanisms or methods.

### SUMMARY OF THE INVENTION

Accordingly, provided are improved systems, devices, products, apparatuses, and/or methods for an automatically sliding leash for quick use with a dog.

According to some non-limiting embodiments or aspects, provided is a slideable leash comprising: a flexible elongated member having a proximal end and a distal end; a handle portion disposed at the proximal end of said flexible elongated member; and a stopper attached to the flexible elongated member at a position at or near the distal end of said flexible elongated member, wherein the handle portion and the flexible elongated member are configured to move unabated through the pass-through engagement until the stopper prevents the distal end of the flexible elongated member from passing through the pass-through engagement.

In some non-limiting embodiments or aspects, the quick leash further comprises a receiving cavity disposed in the stopper, and wherein at least a portion of the flexible elongated member comprises a size greater than a size of the receiving cavity.

In some non-limiting embodiments or aspects, the quick leash further comprises a portion of the flexible elongated member which has an increasing size configured to receive one or more stoppers having different sized receiving cavities.

In some non-limiting embodiments or aspects, the quick leash further comprises a portion of the flexible elongated member having a size greater than the receiving cavity which comprises a knotted section of rope.

In some non-limiting embodiments or aspects, the quick leash further comprises a guide disposed on or proximate to the handle portion, wherein the guide is configured to aid passage of the handle portion through the pass-through engagement.

In some non-limiting embodiments or aspects, the quick leash further comprises the guide comprising a fold or shape.

In some non-limiting embodiments or aspects, the flexible elongated member further comprises a lead portion positioned distally from the stopper, wherein the stopper is removably attached to the flexible elongated member, and wherein positioning of the stopper on the flexible elongated member is adjustable for adjusting length of the lead portion.

In some non-limiting embodiments or aspects, the stopper comprises a pet toy that is removable from the flexible elongated member.

In some non-limiting embodiments or aspects, the stopper is positioned at a desired point on the flexible elongated member.

In some non-limiting embodiments or aspects, the stopper is positioned immediately proximate to the distal end of the flexible elongated member.

In some non-limiting embodiments or aspects, the flexible elongated member further comprises a lead portion, wherein the position of the stopper on the flexible elongated member maximizes length of the lead portion.

In some non-limiting embodiments or aspects, a lead portion may extend from the stopper, wherein length of the lead portion is determined by positioning the stopper at a desired point on the flexible elongated member between the handle portion and the distal end.

In some non-limiting embodiments or aspects, the quick leash system provides a receiving cavity extending through the stopper, wherein a portion of the flexible extended member passes entirely through the receiving cavity, and wherein said portion of the flexible extended member attaches to a more proximal portion of the flexible extended member to secure the stopper.

In some non-limiting embodiments or aspects, the flexible elongated member comprises at least one of a chain, a rope, a strap, a lead, a tether, a restraint, and/or a combination thereof.

In some non-limiting embodiments or aspects, the quick leash system includes a second pass-through engagement, wherein the pass-through engagement and the second pass-through engagement have different sizes.

In some non-limiting embodiments or aspects, the quick leash further comprises an extension engagement disposed on the handle portion, wherein the second pass-through engagement is configured to allow passage of a second quick leash system, the second quick leash system comprising: a second flexible elongated member having a second proximal end and a second distal end; a second handle portion disposed proximate to second proximal end of said second flexible elongated member; and a second stopper attached to the second flexible elongated member at a second position at or near the second distal end of said second rope, wherein the second handle portion and second elongated flexible member are configured to move unabated through the extension engagement until the second stopper prevents the second distal end of the second elongated member from passing through the extension engagement.

According to some non-limiting embodiments or aspects, the quick leash further comprises a method for leashing or leading an animal comprising the steps of: attaching a pass-through engagement to the animal, passing a slidable leash through the pass-through engagement, wherein the slidable leash comprises: a flexible elongated member having a proximal end and a distal end; a handle portion formed on the proximal end of the flexible elongated member, and a stopper attached to the flexible elongated member at a position at or near the distal end of the flexible elongated member, wherein the proximal end is configured to pass through the pass-through engagement prior to the distal end, and wherein the stopper prevents the distal end from passing through the pass-through engagement; and leading the animal for a desired period of time.

In some non-limiting embodiments or aspects, the slidable leash further comprises an extension engagement disposed on the handle portion, and further comprising the steps of: passing a second flexible elongated member of a second slidable leash through the extension engagement, the second slidable leash comprising: a second flexible elongated member having a second proximal end and a second distal end; a second handle portion formed on the second proximal end of said second flexible elongated member; and a second stopper attached to the second flexible elongated member at a position at or near the second distal end of the second elongated member, wherein the second stopper prevents the second distal end of the second flexible elongated member from passing through the extension engagement.

According some non-limiting embodiments or aspects, a slidable leash for leading an animal provides a flexible elongated member having a proximal end, a distal end, and an extended portion connecting the proximal and distal ends, a handle disposed at the proximal end of the flexible elongated member, a stopper attached to the flexible elongated member, and a fixation structure positioned at or near the distal end of the flexible elongated member, the fixation structure configured to prevent the stopper from detaching from the elongated member at the distal end, wherein the flexible elongated member is configured to pass through a pass-through engagement attached to the animal starting at the proximal end, and continuing until the stopper prevents further movement of the flexible elongated member through the pass-through engagement.

In some non-limiting embodiments or aspects, the handle comprises a loop sized to fit a hand of a human user, wherein the flexible elongated member comprises at least one of the following: a chain, a rope, a strap, or any combination thereof, wherein the stopper comprises a receiving cavity having a cross-sectional size that is greater than or equal to a cross-sectional size of the flexible elongated member at a desired position of the stopper on the flexible elongated member, wherein the pass-through engagement comprises a metal ring, the metal ring attached to a collar that is worn by the animal, and wherein the fixation structure comprises at least one of the following: a removable knot, a removable stop, a removable bolt, a crimp, a rope, a chain, a strap, a threaded connector, or any combination thereof, and wherein at least a portion of the fixation structure has a cross-sectional size that is greater than the cross-sectional size of the receiving cavity of the stopper.

In some non-limiting embodiments or aspects, the present disclosure may be characterized by one or more of the following numbered clauses:

Clause 1: A quick leash system, comprising: a flexible elongated member having a proximal end and a distal end, a handle portion disposed at the proximal end of said flexible elongated member, and a stopper attached to the flexible elongated member at a position at or near the distal end of said flexible elongated member, wherein the handle portion and the flexible elongated member are configured to move unabated through the pass-through engagement until the stopper prevents the distal end of the flexible elongated member from passing through the pass-through engagement.

Clause 2: The quick leash system according to clause 1, further comprising a receiving cavity disposed in the stopper, wherein at least a portion of the flexible elongated member comprises a size greater than a size of the receiving cavity.

Clause 3: The quick leash system according to clauses 1 and 2, wherein a portion of the flexible elongated member includes an increasing size configured to receive one or more stoppers having different sized receiving cavities.

Clause 4: The quick leash system according to any of clauses 1-3, wherein the portion of the flexible elongated member having a size greater than the receiving cavity comprises a knotted section of rope.

Clause 5: The quick leash system according to any of clauses 1-4, further comprising a guide disposed on or proximate to the handle portion, wherein the guide is configured to aid passage of the handle portion through the pass-through engagement.

Clause 6: The quick leash system according to clauses 1-5, wherein the guide comprises a fold or shape.

Clause 7: The quick leash system according to any of clauses 1-6, wherein the flexible elongated member further comprises a lead portion positioned distally from the stopper, wherein the stopper is removably attached to the flexible elongated member, and wherein positioning of the stopper on the flexible elongated member is adjustable for adjusting length of the lead portion.

Clause 8: The quick leash system according to any of clauses 1-7, wherein the stopper comprises a pet toy that is removable from the flexible elongated member.

Clause 9: The quick leash system according to any of clauses 1-8, wherein the stopper is positioned at a desired point on the flexible elongated member.

Clause 10: The quick leash system according to any of clauses 1-9, wherein the stopper is positioned immediately proximate to the distal end of the flexible elongated member.

Clause 11: The quick leash system according to any of clauses 1-10, wherein the flexible elongated member further comprises a lead portion, and wherein the position of the stopper on the flexible elongated member maximizes length of the lead portion.

Clause 12: The quick leash system according to any of clauses 1-11, further comprising a lead portion extending from the stopper, wherein length of the lead portion is determined by positioning the stopper at a desired point on the flexible elongated member between the handle portion and the distal end.

Clause 13: The quick leash system according to any of clauses 1-12, further comprising a receiving cavity extending through the stopper, wherein a portion of the flexible extended member passes entirely through the receiving cavity, and wherein said portion of the flexible extended member attaches to a more proximal portion of the flexible extended member to secure the stopper.

Clause 14: The quick leash system according to any of clauses 1-13, wherein the flexible elongated member comprises at least one of a chain, a rope, a strap, a lead, a tether, a restraint, and/or a combination thereof.

Clause 15: The quick leash system according to any of clauses 1-14, further comprising a second pass-through engagement, wherein the pass-through engagement and the second pass-through engagement have different sizes.

Clause 16: The quick leash system according to any of clauses 1-15, further comprising an extension engagement disposed on the handle portion, wherein the second pass-through engagement is configured to allow passage of a second quick leash system, the second quick leash system comprising: a second flexible elongated member having a second proximal end and a second distal end; a second handle portion disposed proximate to the second proximal end of said second flexible elongated member; and a second stopper attached to the second flexible elongated member at a second position at or near the second distal end of said second rope, wherein the second handle portion and second elongated flexible member are configured to move unabated through the extension engagement until the second stopper prevents the second distal end of the second elongated member from passing through the extension engagement.

Clause 17: A method for leashing or leading an animal comprising the steps of: attaching a pass-through engagement to the animal; passing a slidable leash through the pass-through engagement, wherein the slidable leash comprises: a flexible elongated member having a proximal end and a distal end; a handle portion formed on the proximal end of the flexible elongated member; and a stopper attached to the flexible elongated member at a position at or near the distal end of the flexible elongated member, wherein the proximal end is configured to pass through the pass-through engagement prior to the distal end, and wherein the stopper prevents the distal end from passing through the pass-through engagement; and leading the animal for a desired period of time.

Clause 18: The method for leashing or leading an animal according to clause 17, wherein the slidable leash further comprises an extension engagement disposed on the handle portion, and further comprising the step of: passing a second flexible elongated member of a second slidable leash through the extension engagement, the second slidable leash comprising: a second flexible elongated member having a second proximal end and a second distal end; a second handle portion formed on the second proximal end of said second flexible elongated member; and a second stopper attached to the second flexible elongated member at a position at or near the second distal end of the second flexible elongated member, wherein the second stopper prevents the second distal end of the second flexible elongated member from passing through the extension engagement.

Clause 19: A slidable leash for leading an animal, comprising: a flexible elongated member having a proximal end, a distal end, and an extended portion connecting the proximal and distal ends; a handle disposed at the proximal end of the flexible elongated member, a stopper attached to the flexible elongated member; and a fixation structure positioned at or near the distal end of the flexible elongated member, the fixation structure configured to prevent the stopper from detaching from the flexible elongated member at the distal end, wherein the flexible elongated member is configured to pass through a pass-through engagement attached to the animal starting at the proximal end, and continuing until the stopper prevents further movement of the flexible elongated member through the pass-through engagement.

Clause 20: The slidable leash for leading an animal according to clause 19, wherein the handle comprises a loop sized to fit a hand of a user, wherein the flexible elongated member comprises at least one of the following: a chain, a rope, a strap, or any combination thereof, wherein the stopper comprises a receiving cavity having a cross-sectional size that is greater than or equal to the cross-sectional size of the flexible elongated member at a desired position of the stopper on the flexible elongated member, wherein the pass-through engagement comprises a metal ring, the metal ring attached to a collar that is worn by the animal, wherein the fixation structure comprises at least one of the following: a removable knot, a removable stop, a removable bolt, a crimp, a rope, a chain, a strap, a threaded connector, or any combination thereof, and wherein at least a portion of the fixation structure has a cross-sectional size that is greater than the cross-sectional size of the receiving cavity of the stopper.

Clause 21: A quick leash system according to any of clauses 1-16, further comprising a lead portion, wherein the lead portion includes a clip and/or a ring.

Clause 22: The quick leash system according to any of clauses 1-16, wherein the flexible elongated member comprises a braided structure surrounding a hollow lumen.

Clause 23: The slidable leash for leading an animal according to clauses 19 and 20, wherein the flexible elongated member comprises a braided structure surrounding a hollow lumen.

### BRIEF DESCRIPTION OF THE DRAWINGS

FIG. 1 is a diagram of a slidable leash according to some non-limiting embodiments or aspects;

FIG. 2 is a diagram of a slidable leash according to some non-limiting embodiments or aspects;

FIG. 3 is a diagram of a slidable leash according to some non-limiting embodiments or aspects;

FIG. 4 is a diagram of a slidable leash according to some non-limiting embodiments or aspects;

FIG. 5 is a diagram of a slidable leash and a receiving engagement according to some non-limiting embodiments or aspects;

FIG. 6 is a diagram of a slidable leash and a receiving engagement according to some non-limiting embodiments or aspects;

FIG. 7 is an implementation of a slidable leash and a receiving engagement according to some non-limiting embodiments or aspects;

FIG. 8 is an implementation of a slidable leash and a receiving engagement according to some non-limiting embodiments or aspects;

FIG. 9A is a flow chart of a method according to some non-limiting embodiments or aspects;

FIG. 9B is a flow chart of an additional method according to some non-limiting embodiments or aspects; and

FIG. 10 is a cross sectional; diagram of an example of a flexible member according to some non-limiting embodiments or aspects.

### DETAILED DESCRIPTION

As used herein, the singular form of “a,” “an,” and “the” include plural referents unless the context clearly dictates otherwise.

Spatial or directional terms, such as “left,” “right,” “inner,” “outer,” “above,” “below,” and the like, relate to the disclosure as shown in the drawing figures and are not to be considered as limiting as the disclosure can assume various alternative orientations.

All numbers and ranges used in the specification and claims are to be understood as being modified in all instances by the term “about.” By “about” is meant plus or minus twenty-five percent of the stated value, such as plus or minus ten percent of the stated value. However, this should not be considered as limiting to any analysis of the values under the doctrine of equivalents.

The terms “first,” “second,” and the like are not intended to refer to any particular order or chronology, but refer to different conditions, properties, or elements.

The term “at least” is synonymous with “greater than or equal to.”

The term “not greater than” is synonymous with “less than or equal to.”

As used herein, “at least one of” is synonymous with “one or more of.” For example, the phrase “at least one of A, B, and C” means any one of A, B, or C, or any combination of any two or more of A, B, or C. For example, “at least one of A, B, and C” includes one or more of A alone; or one or more B alone; or one or more of C alone; or one or more of A and one or more of B; or one or more of A and one or more of C; or one or more of B and one or more of C; or one or more of all of A, B, and C.

The terms “includes,” “has,” and “having” are synonymous with “comprises” unless otherwise stated. The invention comprises, consists of, or consists essentially of, the following aspects of the invention, in any combination. Various aspects of the invention are illustrated in separate drawing figures. However, it is to be understood that this is simply for ease of illustration and discussion. In the practice of the invention, one or more aspects of the invention shown in one drawing figure can be combined with one or more aspects of the invention shown in one or more of the other drawing figures.

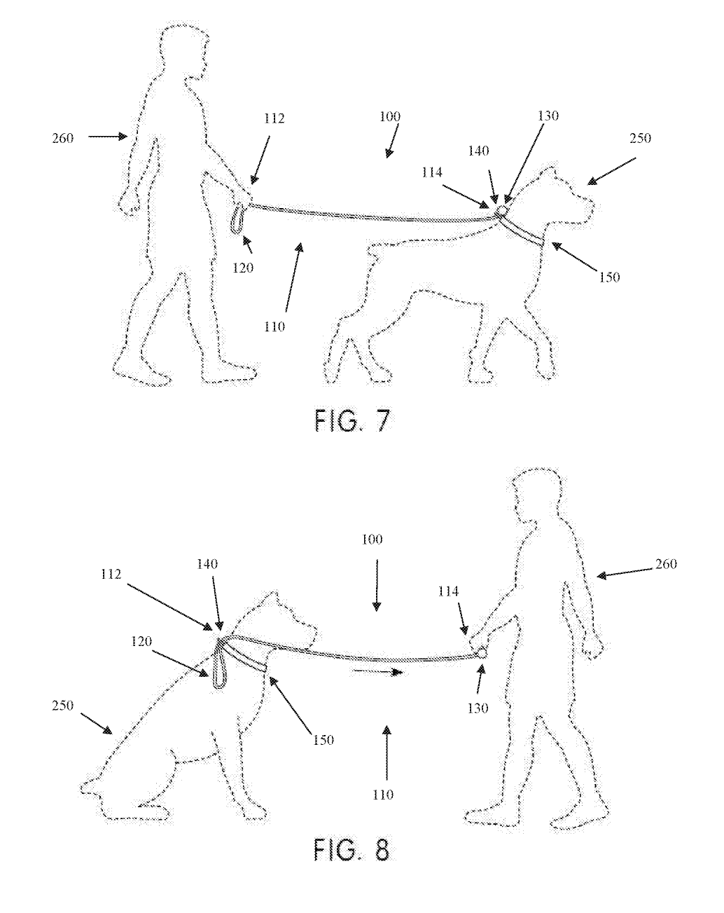

As used, the terms “proximal” and “distal” are oriented relative to a user in control of the handle of the quick leash system when leading an animal, as shown in FIG. 7. It is to be understood, however, that features that are described as “proximal” and “distal” herein do not change if the user changes positions, such as to remove the leash, as shown in FIG. 8.

The term “such as” is to be understood as being non-limiting. That is, the elements recited after “such as” are to be understood as being non-limiting examples of the recited features.

The discussion of the invention may describe certain features as being “particularly” or “preferably” within certain limitations (e.g., “preferably,” “more preferably,” or “even more preferably,” within certain limitations). It is to be understood that the invention is not limited to these particular or preferred limitations but encompasses the entire scope of the disclosure.

Unless otherwise indicated, the terms “attached,” “connected,” and “affixed” may mean fixedly attached, connected, or affixed, removably attached, connected, or affixed, and/or adjustably attached, connected, or affixed.

The quick leash system and slidable leash disclosed herein may differ from any existing leashes as they do not require the use of a “clip.” For example, instead of clipping on as a known leash would attach to a collar or halter; referred to as “collar” hereinafter, the slidable leash according to some non-limiting embodiments or aspects has a new and revolutionary function.

Non-limiting embodiments or aspects of the present disclosure are directed to systems, devices, products, apparatuses, and/or methods for a quick remove and release slideable leash. For example, a quick leash system may provide a slideable leash comprising: a flexible elongated member having a proximal end and a distal end; a handle portion disposed at the proximal end of said flexible elongated member; and a stopper attached to the flexible elongated member at a position at or near the distal end of said flexible elongated member, wherein the handle portion and the flexible elongated member are configured to move unabated through the pass-through engagement until the stopper prevents the distal end of the flexible elongated member from passing through the pass-through engagement. In some non-limiting embodiments or aspects, an example of the slidable leash herein can mate (e.g., combine, etc.) with a collar of an animal by sliding through a pass-through engagement on a collar (e.g., a ring, a carabiner circle, or other engagement, etc.). The handle of the slidable leash herein can be small enough in size to enter and exit a pass-through engagement on a collar efficiently and quickly by human manipulation. After the handle initially is passed through a loop on a collar, the animal may pull away or the slidable leash may be pulled through the pass-through engagement by a user to secure the leash on the animal. On the end opposite of a handle is a stopper. The stopper can always be larger in size than the pass-through engagement on the collar. In an example, a stopper creates a stopping effect as a stopper co-acts with a pass-through engagement on the collar. When secured to a loop on the collar, the leash has the ability to fall forward when there is slack on the clipless leash; however, should the user have ahold of the handle, an animal cannot escape the slidable leash. In this way, the benefits of a slidable leash may provide a more easily used mode of connection and release between two objects (e.g. a pet leash and a collar, etc.). For example, a mechanism for connection of the slideable leash may more easily and quickly be removed than existing clip leashes and may not require and/or may not require a same amount of fine and distinct motor movements of a user to place and remove the slideable leash. Additionally, a connection may be engaged or disengaged with one hand of a user, can provide benefits in various environmental conditions, such as, for example, at a beach, in a snowy area, in an area with water, for activities such as water sports, activities requiring quick removal, activities where a dog must quickly move from an owner's side, activities where ease of use is tantamount (e.g., hunting dogs in the field, multiple dogs, quickly joining two dog chains, entering an automobile, entering a home, etc.).

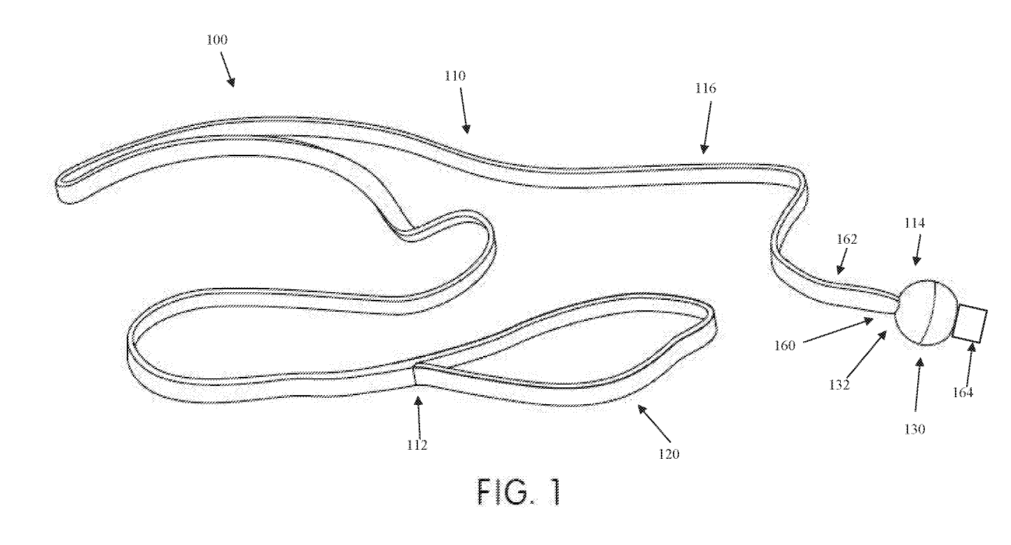

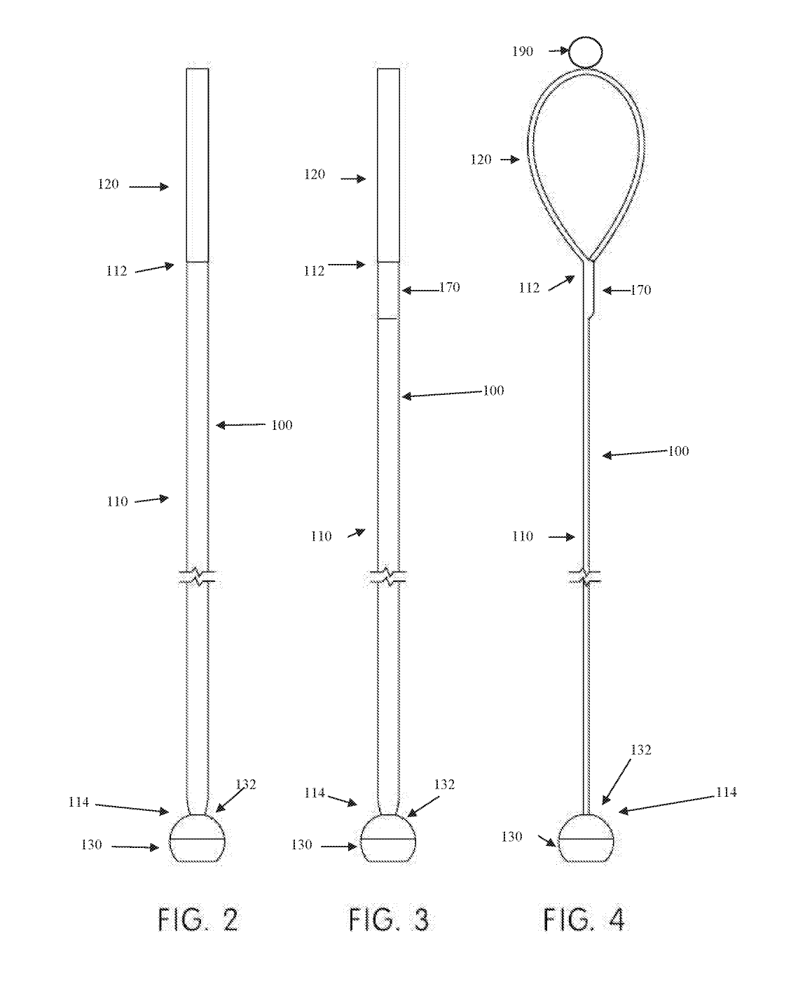

FIGS. 1-4 show a non-limiting embodiment or aspect of a slidable leash 100. The leash 100 includes a flexible elongated member 110 having a proximal end 112, a distal end 114, and an elongated portion 116 spanning between the proximal 112 and distal 114 ends of the leash 100. The flexible elongated member 110 may be made of any suitable material. Examples of suitable materials include rope, cloth, canvas, fabric, leather, flexible plastic, rubber, metal chain, monofilament fiber, carbon fiber, or any material that is sufficiently strong and flexible to secure and lead a desired animal. In one example, not shown in the figures, a flexible elongated member 110 may be made of links of material, such as metal or a polymer material.

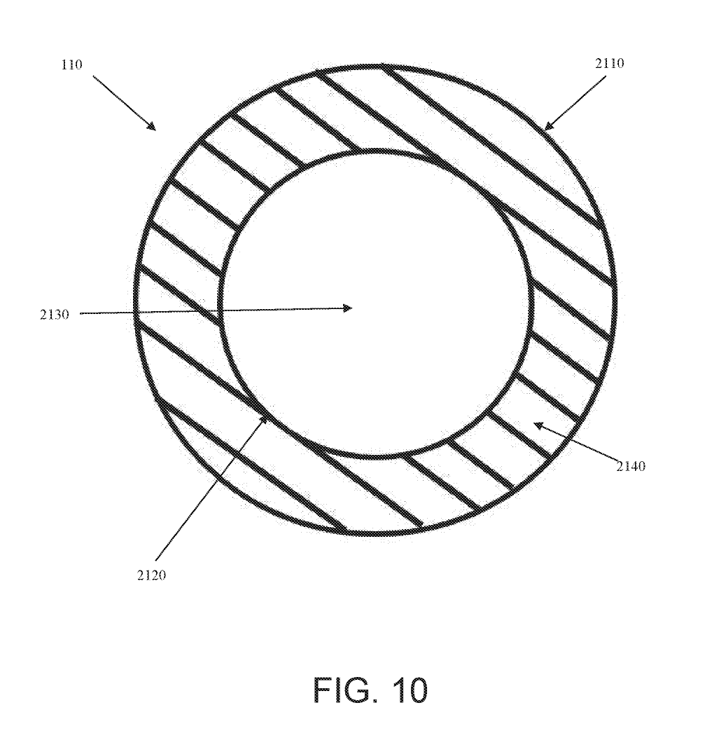

FIG. 10 shows a non-limiting embodiment or aspect of a flexible elongated member 110 according to the present disclosure. According to the cross section, which is taken along a plane through the member 110 that is perpendicular to an axis connecting the proximal 112 and distal 114 ends, the flexible elongated member 110 may comprise a hollow braided structure 2140. The flexible elongated member 110 may be comprised of an outer surface 2110 and an inner surface 2120 surrounding a lumen 2130 that passes along at least a portion of the flexible elongated structure 110 between the proximal end 112 and the distal end 114. The braided structure 2140 is schematically represented in FIG. 10 by diagonal hashing. Examples of the braided structure 2140 may comprise natural or synthetic fibers, such as nylon or polyester. The hollow braided structure 2140 may allow of the construction of a flexible elongated member 110 with a small circumference, or a circumference having an adjustable size. A benefit of such a configuration may be the use of a reduced-size pass-through engagement 130, which may be sized for increased comfort of the animal attached to it. Additionally, a hollow braided structure 2140 configuration may provide a flexible elongated member 110 that is strong and compact.

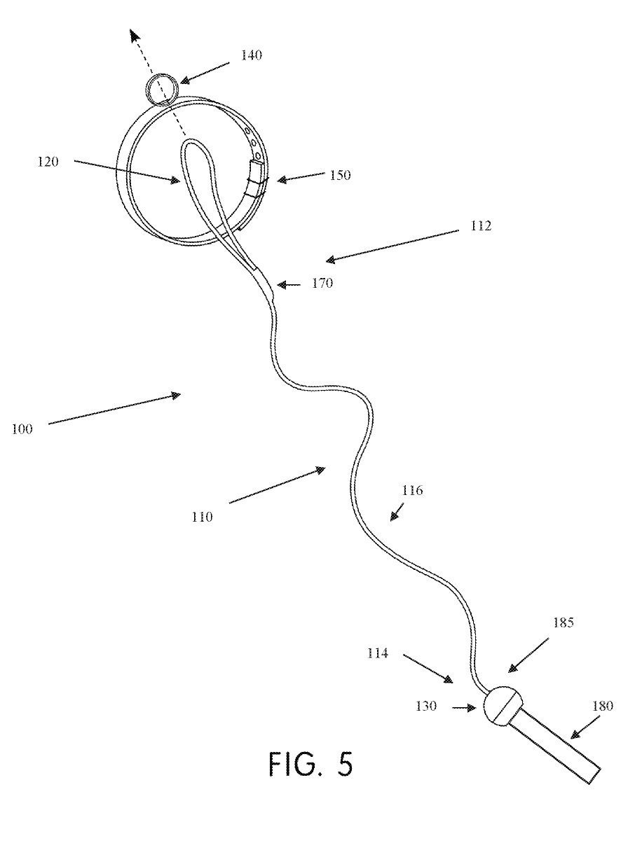

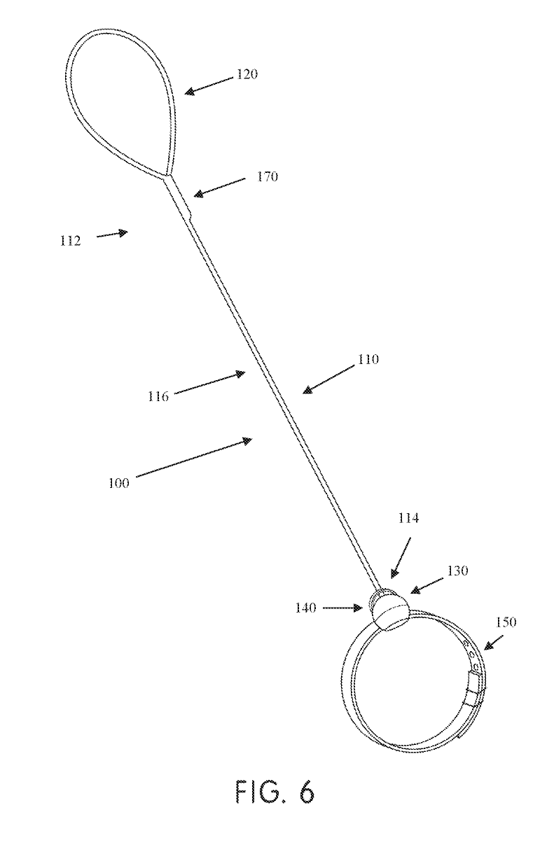

As shown in FIGS. 1-4, examples of the leash 100 may include a handle 120 disposed at the proximal end 112 of the flexible elongated member 110. In some non-limiting embodiments or aspects, handle 120 may be made of the same material used for the elongated portion 116 of the flexible elongated member 110, or of a different material. For example, handle 120 can be sized to comfortably fit the hand of a user. As shown in FIGS. 1-4, the handle 120 may be a loop that fits the hand of a user. In some non-limiting embodiments or aspects, handle 120 can be sized to fit through a pass-through engagement 140, an example of which is shown in FIGS. 5 and 6. Examples of the handle 120 may be flexible. In some non-limiting embodiments or aspects, handle 120 can be integrally-formed with the flexible elongated member 110, or may be separately formed and attached. In an example, handle 120 can be rigid and made of a hard material such as wood or a hard plastic that is sized to fit through a pass-through engagement 140.

With reference to FIGS. 4 and 6, in some non-limiting embodiments or aspects, a leash 100 can include a guide 170 positioned on or near the handle 120. For example, guide 170 can be integrally-formed on the handle 120 or distal end 114 of the flexible elongated member 110, or can be separately formed and attached of the same or different material used to form the flexible elongated member 110 and/or handle 120. In an example, guide 170 can include a tapered configuration to facilitate movement of the handle 120 through the pass-through engagement 140 attached to an animal to be led in one or more directions. For example, guide 170 can comprise a crimp or fold in the material of the handle 120 and/or flexible elongated member 110. Guide 170 can be positioned at or near the point where handle 120 meets the proximal end 112 of the flexible elongated member 110.

In some non-limiting embodiments or aspects, leash 100 can include a guide 170 positioned at the proximal end of handle 120 which can aid insertion of the handle 120 into the pass-through engagement 140. It is to be understood that one or more guides 170 can be disposed on the leash 100 in desired positions to aid in movement of the leash 100 through the pass-through engagement 140.

With reference to FIGS. 1-4, in some non-limiting embodiments or aspects, flexible elongated member 110 provides an extended portion 116 that connects the proximal end 112 and distal end 114. For example, extended portion 116 can be of any desired length. In an example, the length of the extended portion 116 is provided to allow an animal to walk or be led at a deserted distance from a user. In some non-limiting embodiments or aspects, the length of extended portion 116 can be limited based on a length desired by the user in order to better steady or control an animal being led. In additional examples, as more thoroughly described below, it can be preferable that the extended portion 116 have a length that is less than the desired lead length for the animal and for one or more leash systems 100 to be joined together to reach the desired length. Such a configuration can allow for economies of manufacture, use, and/or storage.

With continued reference to FIGS. 1-4, in some non-limiting embodiments or aspects, stopper 130 is positioned on the flexible elongated member 110 distally from the handle 120. As shown in FIGS. 1-4, for example, stopper 130 can be attached at or near the distal end 114 of the flexible elongated member 110. It is to be understood that in some non-limiting embodiments or aspects, stopper 130 also can be positioned at any desired point on the flexible elongated member 110. Examples of stopper 130 can be fixedly attached to the flexible elongated member 110, or removably attached to the flexible elongated member 130.

In some non-limiting embodiments or aspects, stopper 130 can be attached to the flexible elongated member 110 by an external attachment engaging with the outer surface of stopper 130. For example, stopper 130 can be integrally-formed with the flexible elongated member 110. In another example stopper 130 can be attached to the flexible elongated member 110 by an external webbing or skin that surrounds the stopper 130 and affixes to the flexible elongated member 110.

With further reference to FIGS. 1-4, in some non-limiting embodiments or aspects, stopper 130 can include a receiving cavity 132. For example, the receiving cavity 132 can extend partially through the stopper 130, or through the stopper 130 entirely. In some examples, the flexible elongated member 110 can enter the receiving cavity 132 and attach to the stopper 130 inside the receiving cavity 132. In some examples the receiving cavity 132 extends entirely through the body of the stopper 130, and the flexible elongated member 110 can pass through the stopper 130 until the stopper 130 is positioned in a desired location on the elongated member 110. In an example, a length of the flexible elongated member 110 can extend distally beyond the stopper 130. In further examples, this length can be used to form a lead portion, shown schematically in FIG. 5, which can be used to create a lead, such as a rope lead, for the animal to be walked or led.

Referring again to FIGS. 1-4, in some non-limiting embodiments or aspects, receiving cavity 132 can have an appropriate cross-sectional shape to coact with the distal end 114 of the flexible elongated member 110 in order to secure placement of the stopper 130 at a desired position on the flexible elongated member 110. For example, the flexible elongated member 110 can provide one or more portions having a cross-sectional that is less than the cross-sectional size of the receiving cavity 132, allowing movement of the stopper 130 along a portion of the flexible elongated member 110. The flexible elongated member can provide one or more portions having a cross-sectional size that is greater than the cross-sectional size of the receiving cavity 132, which would not allow movement of the stopper 130 on that portion of the member 110. In some non-limiting embodiments or aspects, the cross-sectional size of the flexible elongated member 110 can be varied in order to secure the stopper 130 at a desired position on the flexible elongated member 110.

In some non-limiting embodiments or aspects, flexible elongated member 110 can pass through receiving cavity 132. As an example, a portion of the flexible elongated member 110 that passed through receiving cavity 132 can then be affixed to a more proximal portion of the flexible elongated member 110, forming a loop that attaches stopper 130 to leash 100. For example, a portion of the flexible elongated member 110 that has passed through receiving cavity 132 can be affixed to a more proximal portion of the flexible elongated member 110 in any appropriate manner (e.g., sewing, heat treatment, adhesive, stapling, linking, etc.).

With reference to FIG. 1, in some non-limiting embodiments or aspects, stopper 130 has a receiving cavity 132 that receives the distal end 114 of the flexible elongated member 110. In some non-limiting embodiments or aspects, the flexible elongated member 110 has a portion 160 wherein the cross-sectional size increases going from the distal end 114 in the direction of the proximal end 112. For example, along portion 160, the cross-sectional size of the flexible elongated member 110 becomes greater than the cross-sectional size of the receiving cavity 132. By increasing the cross-sectional size of the flexible elongated member 110 thusly, the maximum proximal position of the stopper 130 can be controlled. In some non-limiting embodiments or aspects, the portion 160 of varying cross-sectional size can be long enough to allow for the attachment of more than one stopper 130 to the flexible elongated member 110. For example, spacing between the more than one stoppers 130 can be maintained by varying the cross-sectional sizes of the receiving cavities 132 of the stoppers 130 (e.g., the stopper 130 having the smaller receiving cavity 132 can be unable to occupy a position on the flexible elongated member 110 that is more proximal than a stopper 130 having a larger receiving cavity 132 could occupy).

In some non-limiting embodiments or aspects, positioning of stopper 130 also can be controlled by use of a fixation structure 164, as shown schematically in FIG. 1. As an example, fixation structures can provide structures that have a larger cross-sectional size than at least a portion of the receiving cavity 132 of stopper 130. For example, a portion of flexible elongated member 110 extending distally from stopper 130 that has a larger cross-sectional size than the receiving cavity 132 provides a fixation structure 164 that can impede movement of stopper 130 distally. In another example, fixation structure 164 can include a knot at the distal end 112 of the flexible elongated member 110, or an apparatus, such as a rigid length of rod, that impedes positional movement, especially distal movement, of stopper 130 on the flexible elongated member 110. For example, as shown in FIG. 1, fixation structure 164 can extend distally beyond the outer surface of stopper 130. In some examples, it is to be understood that a distal portion of the receiving cavity 132 can be enlarged or countersunk to contain the fixation structure 164. In some non-limiting embodiments or aspects, fixation structure 164 can be a knot of rope that can be tied and untied by a user to remove and reattach stopper 130 to the flexible elongated member 110 according to a preference of a user. The receiving cavity 132 of stopper 130 can include an enlarged portion that contains the knot when the leash 100 is in use.

In some non-limiting embodiments or aspects, fixation structure 164 can include one or more mechanical fasteners. For example, a fixation structure 164 can include internal threading in the receiving cavity 132 that co-acts with a corresponding threaded structure, not shown, disposed at a desired position on the flexible elongated member 110. In other examples, fixation structures can include adhesives, locks, or other manners known in the art.

In some non-limiting embodiments or aspects, stopper 130 can be removed (e.g., removably attachable to the flexible elongated member 110, etc.), such as, for example, when fixation structure 164 includes a removable knot or threaded mechanical fastener. In some examples, stopper 130 can be comprised of rubber or hard plastic, and used as a toy to engage the animal and/or the user. In some examples, a toy can be removably attached to stopper 130 by a clip, ring, or hook-and-loop fastener, and removed for use with the animal.

In some non-limiting embodiments or aspects, stopper 130 can be equipped with a spring-loaded or motorized retraction device configured to retract the flexible elongated member into stopper 130 when the leash 100 is not in use. The flexible elongated member 110 can be extracted by mechanical or motorized means when a user desires to use the leash 100.

With reference to FIG. 5, in some non-limiting embodiments or aspects, a pass-through engagement 140 is affixed to a collar 150, which in turn is configured to be attached to an animal that is to be walked or led. For example, a pass-through engagement 140 includes an internal passage that is larger than the flexible elongated member 110, and handle 120, but is smaller than stopper 130. In an example, pass-through engagement 140 includes a material that is sufficiently strong to withstand pulling forces that can be generated by the animal that is being led. For example, pass-through engagement 140 provides a metal ring that is securely affixed to the collar 150. In some non-limiting embodiments or aspects, pass-through engagement 140 is not limited to a circular shape, and can have a d-shape, triangle shape, rectangular shape, rhomboid shape, cylindrical shape, or any shape sufficient to allow passage of the flexible elongated member 110 and impede passage of the stopper 130. In some non-limiting embodiments or aspects, pass-through engagement 140 can comprise a rigid or chain-link ring. In a non-limiting embodiment or aspect, the pass-through engagement 140 can be securely bolted or otherwise affixed to the collar 150, or can encircle the width of the collar 150. An additional non-limiting embodiment or aspect of a pass-through engagement 140 can be a carabiner through which the collar 150 passes. Another example of a pass-through engagement 140 can include a sufficiently-sized passage that is integrally-formed in or on the collar 150, with the material of the collar 150 itself. In some non-limiting embodiments or aspects, pass-through engagement 140 is sized and positioned to minimize friction from the flexible elongated member 110 or collisions with the stopper 130 to avoid discomfort to the animal.

With further reference to FIG. 5, in some non-limiting embodiments or aspects, the leash 100 can comprise a lead portion 180, which can be used to form a lead, such as a rope lead, configured to be used with the animal. The lead portion 180 can be comprised of the flexible elongated member 110, and the length of the lead portion 180 can be adjusted based on positioning of stopper 130 on the extended portion 116 of the flexible elongated member 110 (e.g., the more proximally stopper 130 is positioned, the longer the lead portion 180 can be). In some non-limiting embodiments or aspects, stopper 130 can be configured to be positioned at a desired point 185 on the flexible elongated member 110 in order to result in a desired length of the lead portion 180. Alternatively, the lead portion 180 can be a separate flexible elongated member 110 that is attached directly to the stopper 130. In some non-limiting embodiments or aspects, lead portion 180 can comprise one or more clips and/or rings positioned on lead portion 180.

With reference to FIGS. 5-8, in some non-limiting embodiments or aspects, in order to secure the flexible elongated member 110 to a collar 150 attached to an animal, the flexible elongated member 110 is passed through the pass-through engagement 140 handle-first. For example, guide 170 is positioned either proximally or, as shown, distally on the handle 120, to be used to facilitate threading the flexible elongated member 110 though the pass-through engagement 140. For example, a user can pull the flexible elongated member 110 through pass-through engagement 140 until stopper 130, which is positioned on the flexible elongated member 110, co-acts with pass-through engagement 140 stopping a motion in a proximal direction.

In some non-limiting embodiments or aspects, as shown in FIG. 7, although tension on the leash 100 can increase or slacken based on movement of the animal 250, the flexible elongated member 110 can remain connected to the collar 150 as long as the user 260 holds handle 120, or any other part of the flexible elongated member 110 that is in a proximate direction from the pass-through engagement 140.

In some non-limiting embodiments or aspects, with reference to FIG. 8, a member can be disconnected by taking hold of stopper 130, then pulling the flexible elongated member 110 through the pass-through engagement 140 until it is entirely removed. In an example, guide 170 reduces a likelihood of handle 120 catching on a pass-through engagement 140. In some non-limiting embodiments and aspects, the flexible elongated member 110 can be engaged and disengaged with the collar 150 with the use of only one hand. Further, disengagement of the leash 100 can be easily accomplished in cases where the animal 250 is excited or uncooperative with the human, because the human 260 need not grip the collar 150. In some non-limiting embodiments or aspects, as shown in FIG. 8, a user 260 need only need only grasp stopper 130, and the animal 250 is free to move away from the user 260 as the leash 100 disengages.

With reference to FIG. 4, in some non-limiting embodiments or aspects, the flexible elongated member 110 can include an extension engagement 190 attached to handle 120. For example, extension engagement 190 allows or provides two or more flexible elongated members 110 to be joined together to increase the length of the leash 100. Extension engagement 190 is similar to pass-through engagement 140 in shape and material. For example, extension engagement 190 includes a metal ring that is securely affixed to handle 120. However, in some non-limiting embodiments or aspects, extension engagement 190 is not limited to a circular shape, and can have a d-shape, triangle shape, rectangular shape, rhomboid shape, cylindrical shape, or any shape sufficient to allow passage of the flexible elongated member 110 and impede passage of stopper 130. In some non-limiting embodiments or aspects, extension engagement 190 can comprise a rigid or chain-link ring. In other non-limiting embodiments and aspects, the extension engagement 190 can be securely bolted or otherwise affixed to the handle 120, or can encircle the width of the handle 120. An additional example of an extension engagement 190 can be a carabiner through which a looped handle 120 passes. Another example of an extension engagement 190 can include a sufficiently-sized passage that is integrally-formed in the handle 120, with the material of the handle 120 itself.

In some non-limiting embodiments or aspects, extension engagement 190 can be directly affixed to the proximal portion of handle 120. In such an example, an extension engagement 190 must be smaller than pass-through engagement 140, or be shaped and/or oriented to allow the extension engagement 190 to fit through the internal space of the pass-through engagement 140. Additionally, if more than two flexible elongated members 110 are to be joined using this feature, each extension engagement 190 must be successively smaller in order to allow connection of the next proximately positioned leash, or shaped in such a way that they can pass through the more distally-positioned extension engagement 190 by orienting the more proximal engagement 190 to allow the latter to pass-through the former. In an example, one or more removable extension engagements 190 can be used, and can be affixed to the handle 120 after pass-through. For example, it is not necessary to progressively decrease the sizes of the removable extension engagements 190. An example of a removable extension engagement 190 includes a ring attached to a clip that can be removably attached to the handle 120. Other examples of a removable extension engagement 190 include a ring attached to a looped cord that can be attached to a handle using a cow hitch or other knot.

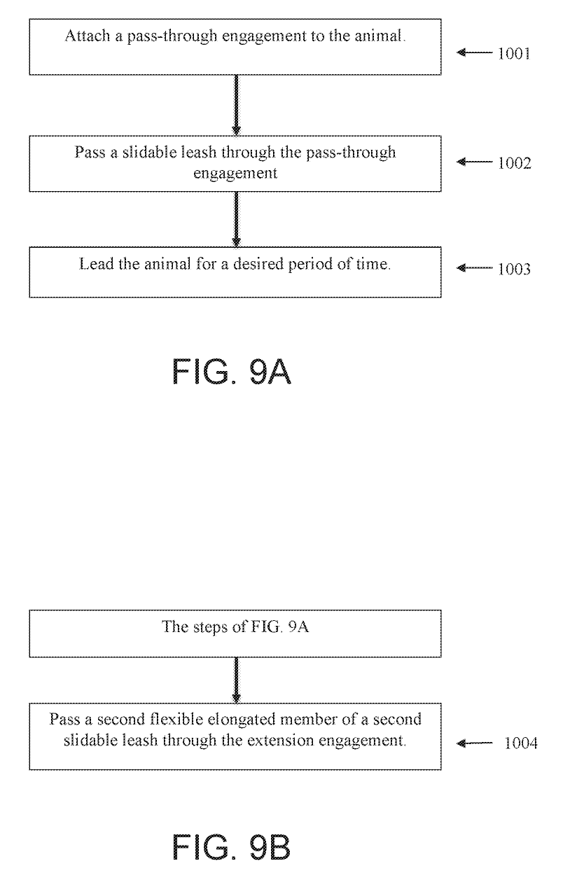

In some non-limiting embodiments or aspects, FIG. 9A shows a flow chart of a method of leading an animal consistent with this disclosure. As shown in FIG. 9A, the method includes step 1001 comprising attaching a pass-through engagement 140 to an animal 250. This can be accomplished, in examples, by attaching a collar 150 to the animal 250, to which the pass-through engagement 140 is affixed.

As shown in FIG. 9A, the method includes step 1002 comprising passing a slidable leash 100 through the pass-through engagement 140. The slidable leash 100 includes a flexible elongated member 110 having a proximal end 112 and a distal end 114; a handle portion 120 formed at the proximal end 112 of the flexible elongated member 110, and a stopper 130 attached to the flexible elongated member 110 at a position at or near the distal end 114 of the flexible elongated member 110, wherein the proximal end 112 is configured to pass through the pass-through engagement 140 prior to the distal end 114, and wherein stopper 130 prevents the distal end 114 from passing through the pass-through engagement 140. For example, step 1002 can be maintained until stopper 130 of the leash 100 stops proximal movement of the leash 100 by coacting with the pass-through engagement 140.

As shown in FIG. 9A, the method includes step 1003 comprising leading the animal for a desired period of time.

With reference to FIG. 9B, a method can include connecting two or more slidable leashes 100 to provide a longer leash wherein the first slidable leash 100 includes an extension engagement 190. As shown in FIG. 9B, the method includes step 1004 comprising passing a second flexible elongated member 110 of a second slidable leash 100 through the extension engagement 190. For example, the second slidable leash 100 comprises a second flexible elongated member 110 having a second proximal end 112 and a second distal end 114; a second handle portion 120 formed on the second proximal end 112 of said second flexible elongated member 110; and a second stopper 130 attached to the second flexible elongated member 110 at a position at or near the second distal end 114 of the second elongated member 110, wherein the second stopper 130 prevents the second distal end 114 of the second flexible elongated member 110 from passing through the extension engagement 190.

In some non-limiting embodiments or aspects, written or diagramed instructions for use of this leash 100 can be printed or otherwise marked on handle 120, stopper 130, and/or along flexible elongated member 110.

In some non-limiting embodiments or aspects, leash 100 can pass through (e.g., can be passed through, etc.) pass-through engagements 140 of multiple animals at the same time. This allows a user to lead multiple animals at once with a single leash 100. Multiple stoppers 130 also can be used in such a configuration, according to user preference. Such a configuration can include the benefit of positioning multiple animals side-by-side as they are walked or led.

In some non-limiting embodiments or aspects, leash 100 can be used, without limitation, with animals such as dogs, cats, horses, goats, pigs, lambs, exotic animals, humans, and/or the like. In the case of turning a horse out to pasture, examples of leash 100 can have the benefit of removing the need of clipping and unclipping the lead from the halter of a horse. Slidable leash 100 provides an effective mechanism to turn out multiple animals effectively. For example, slideable leash 100 can pass through a halter or other standard horse apparatus and quickly be removed, such as, for example, by holding stopper 130 while the animal moves away.

Additionally, examples of the leash 100 can be used to train humans for various activities. For example, when teaching children to ski, snowboard, or for other action sports, known methods include clipping two long ropes into a chest harness worn by the child. When training for such sports, it can be desirable for the child to be let off the lead when he or she is nearing the bottom of the slope, or otherwise is doing well enough that it is desirable to release the child from the lead. However, with known training methods using ropes with clips, if a supervisor desires to do this this they must either drop the ropes, letting them dangle and drag behind the child, or stop the child entirely in order to unlatch the clips from the chest harness. In contrast, examples of leash 100, at the supervising user's discretion, can easily slide out of a pass-through engagement 140 on the child's harness, solving these known problems.

Although the invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the spirit and scope of the appended claims. For example, it is to be understood that the present invention contemplates that, to the extent possible, one or more features of any aspect or embodiment can be combined with one or more features of any other aspect or embodiment.

The invention claimed is:

1. A quick leash system, comprising:
a flexible elongated member having a proximal end and a distal end;
a handle portion disposed at the proximal end of said flexible elongated member; and
a stopper attached to the flexible elongated member at a position at or near the distal end of said flexible elongated member, wherein the handle portion and the flexible elongated member are configured to move unabated through the pass-through engagement until the stopper prevents the distal end of the flexible elongated member from passing through the pass-through engagement.

2. The quick leash system of claim 1, further comprising a receiving cavity disposed in the stopper, wherein at least a portion of the flexible elongated member comprises a size greater than a size of the receiving cavity.

3. The quick leash system of claim 2, wherein a portion of the flexible elongated member includes an increasing size configured to receive one or more stoppers having different sized receiving cavities.

4. The quick leash system of claim 2, wherein the portion of the flexible elongated member having a size greater than the receiving cavity comprises a knotted section of rope.

5. The quick leash system of claim 1, further comprising a guide disposed on or proximate to the handle portion, wherein the guide is configured to aid passage of the handle portion through the pass-through engagement.

6. The quick leash system of claim 5, wherein the guide comprises a fold or shape.

7. The quick leash system of claim 1, wherein the flexible elongated member further comprises a lead portion positioned distally from the stopper, wherein the stopper is removably attached to the flexible elongated member, and wherein positioning of the stopper on the flexible elongated member is adjustable for adjusting length of the lead portion.

8. The quick leash system of claim 1, wherein the stopper comprises a pet toy that is removable from the flexible elongated member.

9. The quick leash system of claim 1, wherein the stopper is positioned at a desired point on the flexible elongated member.

10. The quick leash system of claim 1, wherein the stopper is positioned immediately proximate the distal end of the flexible elongated member.

11. The quick leash system of claim 1, wherein the flexible elongated member further comprises a lead portion, and wherein the position of the stopper on the flexible elongated member maximizes length of the lead portion.

12. The quick leash system of claim 1, further comprising a lead portion extending from the stopper, wherein length of the lead portion is determined by positioning the stopper at a desired point on the flexible elongated member between the handle portion and the distal end.

13. The quick leash system of claim 1, further comprising a receiving cavity extending through the stopper, wherein a portion of the flexible extended member passes entirely through the receiving cavity, and wherein said portion of the flexible extended member attaches to a more proximal portion of the flexible extended member to secure the stopper.

14. The quick leash system of claim 1, wherein the flexible elongated member comprises at least one of a chain, a rope, a strap, a lead, a tether, a restraint, and/or a combination thereof.

15. The quick leash system of claim 1, further comprising a second pass-through engagement, wherein the pass-through engagement and the second pass-through engagement have different sizes.

16. The quick leash system of claim 1, further comprising an extension engagement disposed on the handle portion,
wherein the second pass-through engagement is configured to allow passage of a second quick leash system, the second quick leash system comprising:
a second flexible elongated member having a second proximal end and a second distal end;
a second handle portion disposed proximate to the second proximal end of said second flexible elongated member; and
a second stopper attached to the second flexible elongated member at a second position at or near the second distal end of said second rope, wherein the second handle portion and second elongated flexible member are configured to move unabated through the extension engagement until the second stopper prevents the second distal end of the second elongated member from passing through the extension engagement.

17. A method for leashing or leading an animal comprising the steps of:
attaching a pass-through engagement to the animal;
passing a slidable leash through the pass-through engagement, wherein the slidable leash comprises:
a flexible elongated member having a proximal end and a distal end;
a handle portion formed on the proximal end of the flexible elongated member; and
a stopper attached to the flexible elongated member at a position at or near the distal end of the flexible elongated member,
wherein a proximal end is configured to pass through the pass-through engagement prior to the distal end, and wherein the stopper prevents the distal end from passing through the pass-through engagement; and
leading the animal for a desired period of time.

18. The method according to claim 17, wherein the slidable leash further comprises an extension engagement disposed on the handle portion, and further comprising the step of:
passing a second flexible elongated member of a second slidable leash through the extension engagement, the second slidable leash comprising:
a second flexible elongated member having a second proximal end and a second distal end;
a second handle portion formed on the second proximal end of said second flexible elongated member; and
a second stopper attached to the second flexible elongated member at a position at or near the second distal end of the second flexible elongated member, wherein the second stopper prevents the second distal end of the second flexible elongated member from passing through the extension engagement.

19. A slidable leash for leading an animal, comprising:
a flexible elongated member having a proximal end, a distal end, and an extended portion connecting the proximal and distal ends;
a handle disposed at the proximal end of the flexible elongated member,
a stopper attached to the flexible elongated member; and
a fixation structure positioned at or near the distal end of the flexible elongated member, the fixation structure configured to prevent the stopper from detaching from the flexible elongated member at the distal end,
wherein the flexible elongated member is configured to pass through a pass-through engagement attached to the animal starting at the proximal end and continuing until the stopper prevents further movement of the flexible elongated member through the pass-through engagement.

20. The slidable leash of claim 19, wherein the handle comprises a loop sized to fit a hand of a user,
wherein the flexible elongated member comprises at least one of the following: a chain, a rope, a strap, or any combination thereof,
wherein the stopper comprises a receiving cavity having a cross-sectional size that is greater than or equal to the cross-sectional size of the flexible elongated member at a desired position of the stopper on the flexible elongated member,
wherein the pass-through engagement comprises a metal ring, the metal ring attached to a collar that is worn by the animal,
wherein the fixation structure comprises at least one of the following: a removable knot, a removable stop, a removable bolt, a crimp, a rope, a chain, a strap, a threaded connector, or any combination thereof, and
wherein at least a portion of the fixation structure has a cross-sectional size that is greater than the cross-sectional size of the receiving cavity of the stopper.
